(19) United States
(12) Patent Application Publication
(10) Pub. No.: US 2026/0339604 A1
(43) Pub. Date: Oct. 29, 2026

(54) APPARTUS AND METHOD FOR GENERATING A NETWORK SORTER

(71) Applicants: POSTECH RESEARCH AND BUSINESS DEVELOPMENT FOUNDATION, Pohang-si (KR); AJOU UNIVERSITY INDUSTRY-ACADEMIC COOPERATION FOUNDATION, Suwon-si (KR)

(72) Inventors: Jaehee KIM, Pohang-si (KR); Youngjoo LEE, Pohang-si (KR); Dongyun KAM, Pohang-si (KR); Hyung Il KOO, Suwon-si (KR)

(21) Appl. No.: 19/413,176

(22) Filed: Dec. 9, 2025

(30) Foreign Application Priority Data
Dec. 10, 2024 (KR) 10-2024-0182753
Sep. 15, 2025 (KR) 10-2025-0131474

(51) Int. Cl. G06F 7/24

(52) U.S. Cl. CPC G06F 7/24

(57) ABSTRACT

An apparatus for generating a network sorter comprising: a memory in which a sorter-generation program is stored; and a processor configured to execute the sorter-generation program, wherein the sorter-generation program is configured to receive an input constraint and an output constraint, select a first base architecture from among a plurality of preset base architectures based on the input constraint, and repeatedly perform a local operation on the first base architecture to generate a first sorter, wherein the local operation includes selecting one CAS unit from among a plurality of compare-and-swap (CAS) units constituting the first base architecture, verifying a validity of the CAS unit by determining whether an operation of the first base architecture excluding the CAS unit satisfies the output constraint, and updating the first base architecture by determining whether to remove the CAS unit based on a result of verifying the validity.

### CROSS-REFERENCE TO RELATED APPLICATION

This application claims priority under 35 U.S.C §119 to Korean Patent Application No. 10-2024-0182753, filed on Dec. 10, 2024, and Korean Patent Application No. 10-2025-0131474, filed on Sep. 15, 2025, in the Korean Intellectual Property Office, the contents of which are incorporated herein by reference in their entirety.

### TECHNICAL FIELD

The present disclosure relates to an apparatus and method for generating a network sorter.

### BACKGROUND

The contents described in this section are provided merely as background information for the present embodiment and do not constitute prior art.

A sorting operation is essential in various signal-processing applications such as data compression, communication systems, and machine learning. Since software-based sorting requires numerous memory accesses while performing multiple comparison operations, dedicated sorter hardware is generally preferred to increase overall processing speed. To implement a full-sorting operation for arbitrary inputs, a bitonic architecture is widely used. A bitonic sorter has a regular and parallel structure and is based on a conventional merge-sorting algorithm, and therefore is efficient for full sorting operations.

However, as the number of inputs increases, the number of compare-and-swap (CAS) units increases significantly, requiring more processing stages, which results in a large area and high latency. In addition, a sorter is generally located on a critical path or occupies a significant portion of the chip area.

In practice, application-specific input and output constraints are often given, which provides an opportunity to reduce the burden of a full sorter. Although such constraints have enabled effective reduction of overall hardware complexity in sorter design, the process of identifying unnecessary CAS units fundamentally relies on heuristic methods specialized for specific applications. Moreover, existing approaches require sufficient domain-specific knowledge, and therefore their applicability is limited to the corresponding target applications.

Accordingly, a technique for designing a cost-efficient sorter is required in order to improve overall system performance.

### SUMMARY

An aspects of the present disclosure to provide an apparatus and a method for generating an optimized network sorter by removing unnecessary CAS units based on input constraints and output constraints.

An aspects of the present disclosure are not limited to those mentioned above, and other objects and advantages of the present disclosure that have not been mentioned can be understood by the following description and will be more clearly understood by the embodiments of the present disclosure. Furthermore, it will be readily appreciated that the objects and advantages of the present disclosure can be realized by the means set forth in the claims and combinations thereof.

According to some aspects of the present disclosure, there is provided an apparatus for generating a network sorter which sorts an input signal, the apparatus including: a memory in which a sorter-generation program is stored; and a processor configured to execute the sorter-generation program, wherein the sorter-generation program is configured to receive an input constraint and an output constraint, select a first base architecture from among a plurality of preset base architectures based on the input constraint, and repeatedly perform a local operation on the first base architecture to generate a first sorter, wherein the local operation includes selecting one CAS unit from among a plurality of compare-and-swap (CAS) units constituting the first base architecture, verifying a validity of the CAS unit by determining whether an operation of the first base architecture excluding the CAS unit satisfies the output constraint, and updating the first base architecture by determining whether to remove the CAS unit based on a result of verifying the validity.

According to some aspects, the sorter-generation program may input input data to the first base architecture excluding the CAS unit to generate output data, and perform validity verification on the CAS unit by determining whether the output data satisfies the output constraint.

According to some aspects, the sorter-generation program may determine that the CAS unit does not affect the operation of the first base architecture when the output data satisfies the output constraint, and update the first base architecture by removing the CAS unit from the first base architecture.

According to some aspects, the sorter-generation program may determine that the CAS unit affects the operation of the first base architecture when the output data does not satisfy the output constraint, and update the first base architecture by restoring the CAS unit to the first base architecture.

According to some aspects, a value of each signal included in the input data may be set to 0 or 1, and the sorter-generation program may perform validity verification on the CAS unit by comparing first output data of the first base architecture excluding the CAS unit for the input data consisting of 0s and 1s with second output data that satisfies the output constraint.

According to some aspects, the sorter-generation program may rearrange each signal of the first input data to generate second input data, and perform validity verification on the CAS unit using the second input data.

According to some aspects, the sorter-generation program may divide n signals included in the first input data into m groups (n > m), and generate the second input data by rearranging at least one signal included in a first group to a second group.

According to some aspects, the sorter-generation program may generate the sorter by repeating the local operation a number of local iterations for the base architecture.

According to some aspects, the sorter-generation program may compare an efficiency between a generated sorter and a temporary sorter, and set a sorter with a higher efficiency as the temporary sorter, and the efficiency may be calculated based on a number of CAS units and a number of steps.

According to some aspects, the sorter-generation program may provide a sorter set in the temporary sorter as a final sorter if the generating of the sorter has been repeated a number of global iterations.

According to some aspects, the sorter-generation program may select one of the plurality of base architectures and repeatedly perform the local operation if the generating of the sorter has been repeated less than the number of global iterations.

According to some aspects, the input constraint may include a number of input signals and relationship information for each input signal value, and the output constraint may include a sorting condition of the input signals.

According to some aspects of the present disclosure, there is provided a method of generating a network sorter for sorting an input signal using an apparatus for generating a network sorter, the method including: receiving an input constraint and an output constraint; selecting a first base architecture from among a plurality of preset base architectures based on the input constraint; and generating a first sorter by repeatedly performing a local operation for the first base architecture, wherein the local operation includes: selecting one CAS unit among a plurality of compare-and-swap (CAS) units constituting the first base architecture; verifying validity of the CAS unit by determining whether an operation of the first base architecture excluding the CAS unit satisfies the output constraint; and updating the first base architecture by determining whether to remove the CAS unit based on a result of verifying the validity.

According to some aspects, the verifying of the validity of the CAS may include inputting input data to the first base architecture excluding the CAS unit to generate output data, and performing validity verification on the CAS unit by determining whether the output data satisfies the output constraint.

According to some aspects, the verifying of the validity of the CAS unit may include determining that the CAS unit does not affect the operation of the first base architecture if the output data satisfies the output constraint, and the updating of the first base architecture may include updating the first base architecture by removing the CAS unit from the first base architecture.

According to some aspects, the verifying of the validity of the CAS unit may include determining that the CAS unit affects the operation of the first base architecture if the output data does not satisfy the output constraint, and the updating of the first base architecture may include updating the first base architecture by restoring the CAS unit to the first base architecture.

According to some aspects, a value of each signal included in the input data may be set to 0 or 1, and the verifying of the validity of the CAS unit may include performing validity verification on the CAS unit by comparing first output data of the first base architecture excluding the CAS unit for the input data consisting of 0s and 1s with second output data that satisfies the output constraint.

According to some aspects, the verifying of the validity of the CAS unit may include rearranging each signal of the first input data to generate second input data, and performing validity verification on the CAS unit using the second input data.

According to some aspects, the verifying of the validity of the CAS unit may include dividing n signals included in the first input data into m groups (n > m), and generating the second input data by rearranging at least one signal included in a first group to a second group.

According to some aspects, the generating of the first sorter may include generating the first sorter by repeating the local operation a number of local iterations for the first base architecture.

According to some aspects, the method may further include comparing an efficiency between the first sorter and a temporary sorter, and setting a sorter with a higher efficiency as the temporary sorter, wherein the efficiency is calculated based on a number of CAS units and a number of steps.

According to some aspects, the method may further include providing a sorter set in the temporary sorter as a final sorter if the sorter has been generated a number of global iterations.

According to some aspects, the method may further include selecting the base architecture if the sorter is generated less than the number of global iterations.

The network sorter generating apparatus and method of the present disclosure may generate an efficient sorter by minimizing hardware complexity through a process of repeatedly removing CAS units and verifying the removed units.

In addition, since the validity of a CAS unit is verified using input data composed of 0 and 1, the verification speed may be increased in the validity verification process.

In addition to the foregoing description, specific effects of the present disclosure will be described together while describing specific details for practicing the present disclosure below.

### BRIEF DESCRIPTION OF THE DRAWINGS

FIG. 1 is a block diagram schematically illustrating a configuration of a network sorter generating apparatus according to one embodiment of the present disclosure.

FIG. 2 is a block diagram schematically illustrating an operation of a network sorter generating apparatus according to the present disclosure.

FIG. 3 is an exemplary diagram illustrating an operation corresponding to a case in which validity verification of a CAS unit fails.

FIG. 4 is an exemplary diagram illustrating an operation corresponding to a case in which validity verification of a CAS unit is successful.

FIG. 5 is an exemplary diagram illustrating an operation of redistributing input data.

FIG. 6 is an exemplary diagram illustrating a local operation.

FIG. 7 is a flowchart illustrating a method for generating a network sorter according to one embodiment of the present disclosure.

FIG. 8 is a flowchart illustrating a process of repeatedly performing the local operation shown in FIG. 7.

FIG. 9 is a flowchart illustrating a process of verifying validity of a CAS unit shown in FIG. 8.

### DETAILED DESCRIPTION OF THE PREFERRED EMBODIMENTS

The terms and words used in the present specification and the claims should not be interpreted as being limited to their ordinary or dictionary meanings. According to the principle that an inventor may define the meanings of terms or words in order to best describe his or her own invention, the terms should be interpreted in meanings and concepts consistent with the technical spirit of the present disclosure. In addition, the embodiments described in the present specification and the configurations illustrated in the drawings are merely exemplary embodiments in which the present disclosure is implemented and do not represent the entirety of the technical spirit of the present disclosure, and therefore it should be understood that various equivalents, modifications, and applicable examples capable of replacing them at the time of filing may exist.

The terms such as first, second, A, and B used in the present specification and the claims may be used to describe various components, but the components should not be limited by such terms. Such terms are used only for the purpose of distinguishing one component from another. For example, without departing from the scope of the present disclosure, a first component may be referred to as a second component, and similarly, the second component may also be referred to as the first component. The term “and/or” includes a combination of a plurality of associated listed items or any one of the plurality of associated listed items.

The terms used in the present specification and the claims are merely used to describe specific embodiments and are not intended to limit the present disclosure. A singular form is intended to include a plural form unless the context clearly indicates otherwise. In the present application, terms such as “include” or “have” should be understood as not precluding the presence or addition of features, numbers, steps, operations, components, parts, or combinations thereof described in the specification.

Unless otherwise defined, all terms used herein, including technical or scientific terms, have the same meanings as those generally understood by a person of ordinary skill in the technical field to which the present disclosure pertains.

Terms that are defined in commonly used dictionaries should be interpreted as having meanings consistent with the contextual meanings in the relevant art and should not be interpreted in an idealized or overly formal sense unless expressly defined in the present application.

In addition, each configuration, process, procedure, or method included in each embodiment of the present disclosure may be shared to the extent that they are not technically inconsistent with one another.

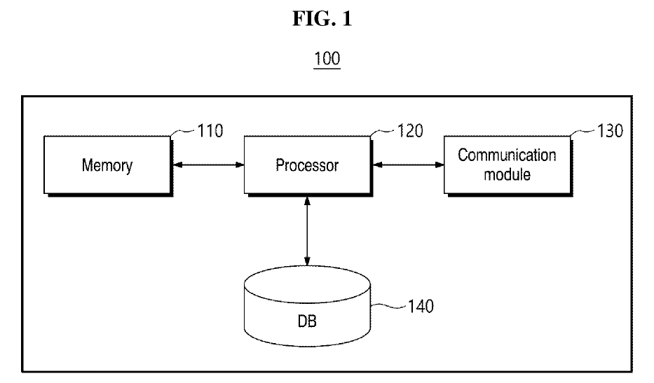

Hereinafter, embodiments of the present disclosure relating to an apparatus and method for generating a network sorter will be described in detail with reference to FIGS. 1 to 9.

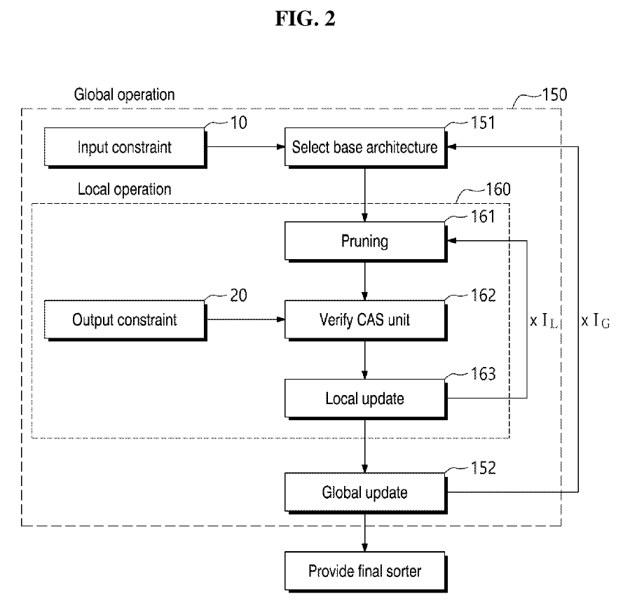

FIG. 1 is a block diagram schematically illustrating a configuration of a network sorter generating apparatus according to one embodiment of the present disclosure, and FIG. 2 is a block diagram schematically illustrating an operation of the network sorter generating apparatus according to the present disclosure.

A description of the network sorter generating apparatus will be provided with reference to FIGS. 1 and 2. The network sorter generating apparatus 100 may generate a network sorter that satisfies input constraints and output constraints. The network sorter may sort input signals in accordance with the output constraints.

Specifically, the network sorter generating apparatus 100 may select a first base architecture from among a plurality of preset base architectures based on input constraints, and may select a first (compare-and-swap) CAS unit, which is one of a plurality of CAS units included in the first base architecture.

Then, the first CAS unit may be excluded from the base architecture, and the apparatus may verify validity of the first CAS unit by determining whether operation of the base architecture from which the first CAS unit has been removed satisfies the output constraints. Based on a result of the validity verification, the apparatus may determine whether to remove the corresponding CAS unit and update the base architecture accordingly. Here, the validity verification verifies whether the CAS unit is a unit that can be removed, and may distinguish between success and failure by determining whether the CAS unit affects operation of the base architecture. A success in the validity verification indicates that the CAS unit does not affect operation of the base architecture and is therefore a removable unit, whereas a failure indicates that the CAS unit affects operation of the base architecture and is therefore a non-removable unit. That is, the validity verification is to identify CAS units that can be removed.

When the base architecture is updated according to the validity verification result for the first CAS unit, the network sorter generating apparatus 100 may again select a second CAS unit from among the plurality of CAS units and generate a first sorter using the first base architecture by repeatedly updating the first base architecture based on validity verification of the second CAS unit for a predetermined number of local iterations.

The network sorter generating apparatus 100 may generate a first sorter using the first base architecture by repeatedly performing a local operation that includes identifying CAS units removable from the base architecture and updating the base architecture accordingly.

Thereafter, once the first sorter is generated, the network sorter generating apparatus 100 may compare the efficiency of the sorter set in the temporary sorter with that of the first sorter and update the temporary sorter with a sorter that exhibits higher efficiency. Here, the efficiency may be calculated based on the number of CAS units and the number of stages of the sorter. That is, the efficiency may be calculated to be higher when the sorter includes fewer CAS units and has fewer stages.

When the temporary sorter is updated, the network sorter generating apparatus 100 may again select a second basic architecture from among the plurality of preset basic architectures, repeatedly perform the local operation on the second basic architecture to generate a second sorter, and update the temporary sorter by comparing an efficiency of the second sorter with that of the temporary sorter.

In this way, by repeatedly performing the global operation of generating a sorter and updating the temporary sorter, a final sorter having the highest efficiency can be provided.

To perform these operations, the network sorter generating apparatus 100 may include a memory 110 and a processor 120.

The memory 110 may store a sorter-generation program configured to generate a sorter that satisfies the input and output constraints. The memory 110 may be interpreted as collectively referring to a non-volatile storage device that retains stored information even when power is not supplied, and a volatile storage device that requires power to maintain stored information. In addition, the memory 110 may perform a function of temporarily or permanently storing data processed by the processor 120. The memory 110 may include non-volatile storage devices, such as magnetic storage media or flash storage media, in addition to volatile storage devices that require power to retain stored information, although the scope of the present disclosure is not limited thereto.

The processor 120 may execute the sorter-generation program stored in the memory 110 to select one of the plurality of CAS units included in the base architecture, perform a validity check on the selected CAS unit, and repeatedly remove or retain the CAS unit, thereby generating a sorter that satisfies the input and output constraints.

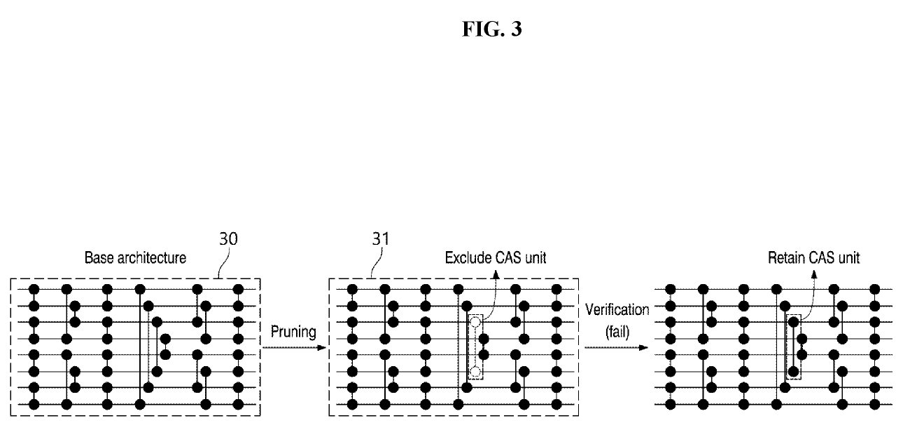

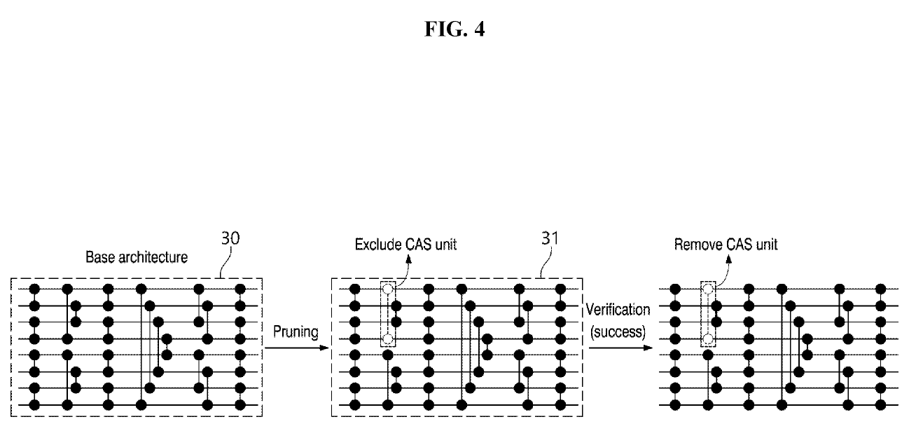

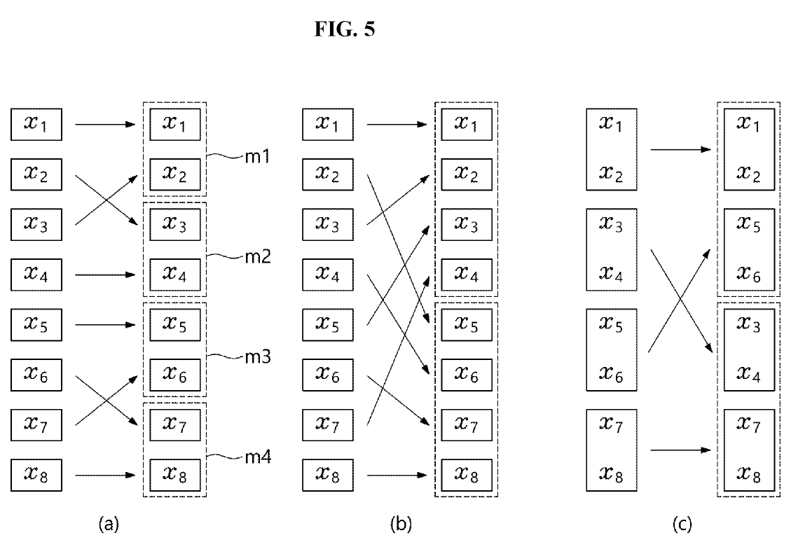

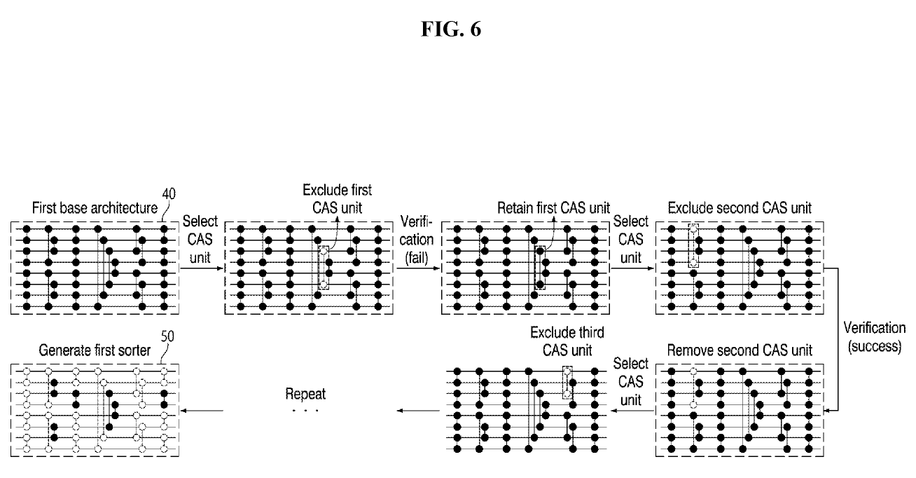

FIG. 3 is an exemplary diagram illustrating an operation in a case where validity checking of a CAS unit fails, FIG. 4 is an exemplary diagram illustrating an operation in a case where validity checking of a CAS unit succeeds, FIG. 5 is an exemplary diagram illustrating a local operation, and FIG. 6 is an exemplary diagram illustrating an operation of redistributing input data.

The operation of the sorter-generation program will now be described in more detail with reference to FIGS. 2 to 6.

Referring to FIG. 2, the sorter-generation program receives input constraints 10 and output constraints 20, and, based on these, repeatedly performs a global operation 150 and a local operation 160 to generate a plurality of sorters, and finally provides a sorter having the highest efficiency among them.

At this time, the global operation 150 is an operation of generating a sorter and determining, based on the efficiency of the generated sorter, whether to retain or discard the sorter, and the local operation 160 is included in the global operation 150 and is an operation of generating a sorter by adjusting the base architecture through removal or retention of CAS units included in the base architecture. Accordingly, the sorter-generation program repeatedly performs the global operation 150 to generate a plurality of sorters, and provides, as a final sorter, the sorter having the highest efficiency among them. Efficiency may be calculated based on the number of CAS units included in the generated sorter and the number of stages thereof.

Here, the input constraint 10 may include the number of input signals of the sorter and information on relationships among the respective signals. For example, the relationship information may include information regarding multiple signals, such as that a signal value at index no. 1 is always smaller, or that an odd-indexed signal value is greater than an even-indexed signal value. The input constraints 10 based on such information may indicate, for example, that there are eight inputs and that the signal value at index no. 3 is the largest.

In addition, the output constraints may include sorting conditions for the input signals. For example, the output constraints may include sorting conditions such as sorting the plurality of input signals in ascending order, sorting them in descending order, or sorting only the five largest signal values.

Next, the global operation 150 of the sorter-generation program will be described.

The sorter-generation program performs a global operation 150 including selecting a base architecture 151, repeatedly performing the local operation 160 on the selected base architecture to generate a sorter, and updating 152 a temporary sorter based on the generated sorter. That is, when a base architecture selection operation 151, repeated local operations 160 on the selected base architecture, and a temporary sorter update operation 152 are performed, one cycle of the global operation 150 is completed. That is, through one cycle of the global operation 150, a sorter is generated and the temporary sorter may be updated.

Next, each operation included in the global operation 150 will be described.

First, the base architecture selection operation 151 is an operation of selecting one base architecture from among a plurality of preset base architectures. Here, the base architecture may be a sorting architecture such as a Bitonic sorter, an odd-even sorter, a hybrid sorter, or a pairwise sorter, and a basic architecture may be selected based on the number of input signals included in the input constraints 10. For example, when the number of input signals included in the input constraints is eight, an eight-input Bitonic sorter may be selected as the base architecture.

Next, the local operation 160 is an operation of generating a sorter by removing or retaining CAS units based on the validity verification of the CAS units included in the base architecture. More specifically, with respect to the local operation 160, the sorter-generation program selects one CAS unit from among the plurality of CAS units that constitute the base architecture. This operation may be referred to as a pruning operation 161.

Here, the base architecture may include a plurality of stages, and each stage may include at least one CAS unit. That is, the base architecture performs an operation in which, through CAS units included in each of the plurality of stages, any two signals are compared and either swapped or left unchanged. The pruning operation 161 for the base architecture may randomly select one CAS unit from among all CAS units included in all stages of the base architecture.

Thereafter, the sorter-generation program determines whether an operation of the base architecture, excluding the selected CAS unit, satisfies the output constraints. Such an operation may be referred to as a CAS unit validity verification operation 162. And the sorter-generation program updates the base architecture by removing or retaining the CAS unit based on the result of the validity verification. This may be referred to as a base architecture update operation 163.

A single cycle of the local operation 160 may include a pruning operation 161, a CAS unit validity verification operation 162, and a base architecture update operation 163, and one cycle may be applied to one CAS unit.

Referring to FIGS. 3 and 4, one cycle of the local operation 160 is described below. Referring to FIG. 3, the sorter-generation program selects one CAS unit among a plurality of CAS units constituting the base architecture 30 and excludes the selected CAS unit from the base architecture 30.

Then, input data is input into the base architecture 31 excluding the selected CAS unit, and the validity of the CAS unit is verified by determining whether the operation of the base architecture 31 excluding the selected CAS unit satisfies the output constraints. Validation is to determine whether the CAS unit affects the operation of the base architecture 30.

FIG. 3 shows a case where the validity verification of the corresponding CAS unit fails, and if the corresponding CAS unit is excluded, the base architecture does not operate properly. That is, it failed to select a CAS unit that can be removed. If validation for the CAS unit fails as shown in FIG. 3, an update is performed to restore the CAS unit to the base architecture.

On the other hand, FIG. 4 shows a case where the validity verification of the CAS unit is successful, and the base architecture operates correctly even if the CAS unit is excluded. That is, selection of a CAS unit that can be removed is successful. If the validity verification for the CAS unit is successful as shown in FIG. 4, an update is performed to remove the CAS unit from the base architecture, thereby updating the base architecture.

In this way, one cycle of the local operation 160 may operate with two results.

Next, the validity verification operation will be specifically described with reference to FIGS. 3 to 5. The sorter-generation program may provide input data into the base architecture 31 excluding the selected CAS unit to generate output data, and perform a CAS unit validity verification operation 162 by determining whether the output data satisfies output constraints.

At this time, the sorter-generation program determines that if the output data satisfies the output constraints, the corresponding CAS unit does not affect the operation of the base architecture 30, and if the output data does not satisfy the output constraints, the corresponding CAS unit determines that the corresponding CAS unit affects the operation of the base architecture 30.

Here, the input data includes a plurality of signals, and each signal value may be set to 0 and 1. For example, if the base architecture is 4 inputs, the input data may be [0, 1, 1, 0].

The sorter-generation program inputs input data consisting of 0 and 1 into the base architecture 31 from which the selected CAS unit has been removed to generate output data, and performs validity verification on the corresponding CAS unit by comparing the output data with the output constraints. For example, if the input data is [0, 1, 1, 0] and the output constraint is to sort in ascending order, it is possible to determine whether the CAS unit affects the operation of the base architecture 30 by checking whether the output data is sorted as [0, 0, 1, 1].

At this time, the sorter-generation program can rearrange a plurality of signals included in the input data to generate new input data, and input the new input data into the base architecture 31 from which the corresponding CAS unit has been removed, to perform validity verification on the corresponding CAS unit.

The sorter-generation program may divide n signal values included in the first input data into m groups (n > m), and may generate second input data by rearranging at least one signal value included in a first group to a second group. A plurality of input data generated in this manner may be input into the base architecture 31 from which the CAS unit has been removed, to perform validity verification on the CAS unit.

The operation of the sorter-generation program to rearrange input data is explained as an example with reference to FIG. 5. Referring to (a) of FIG. 5, the first input data is 8 inputs, and each signal contains only one signal value. The sorter-generation program may divide the eight signals included in the first input data into four groups each consisting of two signals, and rearrange at least one signal included in each group to another group to generate second input data. That is, the second signal among the first and second signals included in the first group (m1) may be rearranged to the second group (m2), and the third signal included in the second group (m2) may be rearranged to the first group (m1) to generate the second input data.

And, (b) of FIG. 5 shows an operation of dividing eight signals into two groups each consisting of four signals, and rearranging three signals in each group by exchanging them, and (c) of FIG. 5 shows an operation of dividing four signals into two groups each consisting of two signals, each signal including two signal values, and rearranging one signal by exchanging it. In FIG. 5, each group is depicted as containing the same number of signals, but this is not limited to the case, and each group may contain a different number of signals.

The sorter-generation program may rearrange input data in this way to generate a plurality of different input data, and input the plurality of input data into the base architecture 31 from which the corresponding CAS unit has been removed, to generate a plurality of output data. Further, a validity verification operation 162 for the corresponding CAS unit may be performed based on the plurality of output data. For example, validity verification may be performed by comparing the first output data of the base architecture excluding the corresponding CAS unit for the input data with the second output data that satisfies the output constraints. If the first output data and the second output data are the same, validity verification is successful. If there is a difference, validity verification may fail. Afterwards, a base architecture update operation 163 may be performed based on the validity verification results.

The sorter-generation program may perform a local operation 160 by repeating, for the number of local iterations (IL), a cycle consisting of a pruning operation 161, a CAS unit validity verification operation 162, and a local update operation 163, and may generate a sorter for the base architecture 30 through the local operation 160.

Next, the global update operation 152 of the global operation 150 is described. The global update operation 152 is an update operation that compares the efficiency of the sorter created through the local operation 160 with that of the sorter set in the temporary sorter and maintains the sorter set in the temporary sorter or changes the temporary sorter to the created sorter. Here, efficiency is calculated based on the number of CAS units and the number of steps included in the sorter, and the smaller the number of CAS units and the smaller the number of steps, the higher the efficiency.

The sorter-generation program may generate a plurality of sorters by repeating the global operation consisting of the base architecture selection operation 151, the local operation 160, and the global update operation 152 by the number of global iterations (IG), and finally provide the sorter with the highest efficiency among them.

An operation of providing a final sorter by repeating a global operation 150 is illustrated with reference to FIGS. 2 and 6.

The sorter-generation program selects 151 a first base architecture 40 from among a plurality of base architectures based on input constraints 10, and performs a pruning operation 161 to select a first CAS unit from the first base architecture 40. Thereafter, a validity verification operation 162 is performed for the first CAS unit. Since the first CAS unit is a unit that has failed validity verification, an update operation 163 is performed to restore the first CAS unit back to the first base architecture 40.

When the cycle for the first CAS unit in the local operation 160 is completed, the sorter-generation program selects the second CAS unit in the first base architecture 40 and performs a pruning operation 161 and a validity verification operation 162 for the second CAS unit. Since the second CAS unit is a unit that has successfully passed validity verification, the first base architecture 40 may be updated by removing the second CAS unit from the first base architecture 40.

The sorter-generation program may generate a first sorter 50 for the first base architecture 40 by repeating a cycle consisting of a pruning operation 161, a CAS unit validity verification operation 162, and an update operation 163 by the number of local iterations (IL).

When a first sorter 50 using the first base architecture 40 is generated through a local operation 150, the sorter-generation program performs a global update operation 152 of comparing the efficiency between the first sorter 50 and the sorter set as a temporary sorter, and setting the sorter with higher efficiency as the temporary sorter. Here, the temporary sorter is set to the initially generated sorter at the beginning of the operation, and may be updated by comparing the efficiency between the sorter created as the iteration of the local operation 160 ends, and the sorter set to the temporary sorter. In this example, it is assumed that the first sorter 50 is created for the first time, and the first sorter 50 is set in the temporary sorter.

In this way, when the global update operation 152 is completed, one cycle of global operation 150 ends. The sorter-generation program may determine whether the global operation 150 has been repeated the number of global iterations (IG), i.e., whether the sorter has been generated the number of global iterations (IG), and may perform the global operation 150 again or provide a final sorter depending on the number of sorter generations.

If the sorter is generated less than the number of global iterations (IG), the sorter-generation program performs a base architecture selection operation 151 to select a second base architecture from among a plurality of preset base architectures, performs a local operation 160 for the second base architecture to generate a second sorter using the second base architecture, compares the efficiency between the generated second sorter and the first sorter set in the temporary sorter, and performs a global update operation 152 to update the temporary sorter based on the comparison result. Here, if the efficiency of the second sorter is higher than that of the first sorter, the second sorter is set in the temporary sorter, otherwise, the temporary sorter may maintain the first sorter.

On the other hand, if the sorter is created for the number of global iterations (IG), the sorter-generation program may provide the sorter set in the temporary sorter as the final sorter.

That is, sorters are created as many times as the number of global iterations (IG), and the most efficient sorter may be set in the temporary sorter and be finally provided. For example, if the number of global iterations (IG) is 50, sorters may be generated from the first to the 50th sorter, and each time a sorter is generated, the efficiency is compared with the sorter set in the temporary sorter, and the sorter set in the temporary sorter may be maintained, or the temporary sorter may be updated with the generated sorter.

Additionally, the sorter-generation program may store all sorters generated in each global operation 150 without performing a global update operation 152 that updates the temporary sorter in the global operation 150, and provide the most efficient sorter among them as the final sorter.

Meanwhile, the processor 120 may perform hardware control functions such as file system, memory allocation, network, basic library, timer, device control (display, media, input device, 3D, etc.), and other utilities required when executing a program. In this embodiment, the processor 120 may be implemented in the form of a microprocessor, a central processing unit (CPU), a processor core, a multiprocessor, an application-specific integrated circuit (ASIC), a field programmable gate array (FPGA), etc., but the scope of the present disclosure is not limited thereto.

Additionally, the communication module 130 may include a device including hardware and software required to transmit and receive signals, such as control signals or data signals, through wired or wireless connections with other network devices in order to perform data communication for signal data with external devices. The database (140) can store various data for the sorter generation program to operate, such as multiple basic architectures.

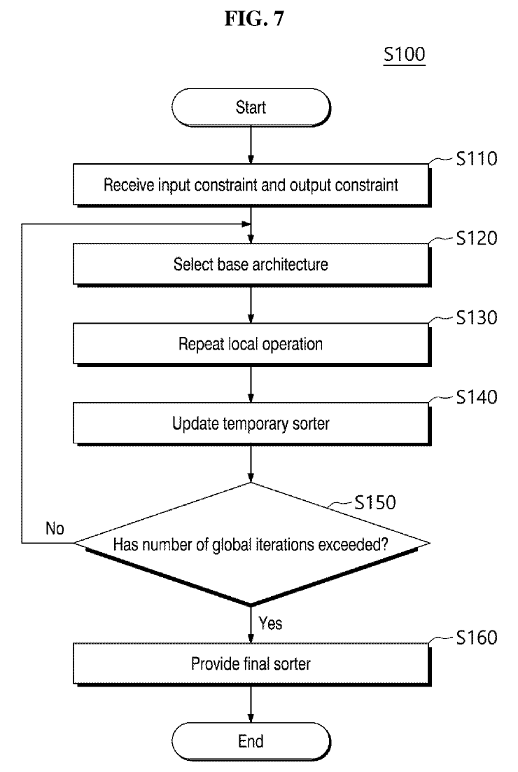

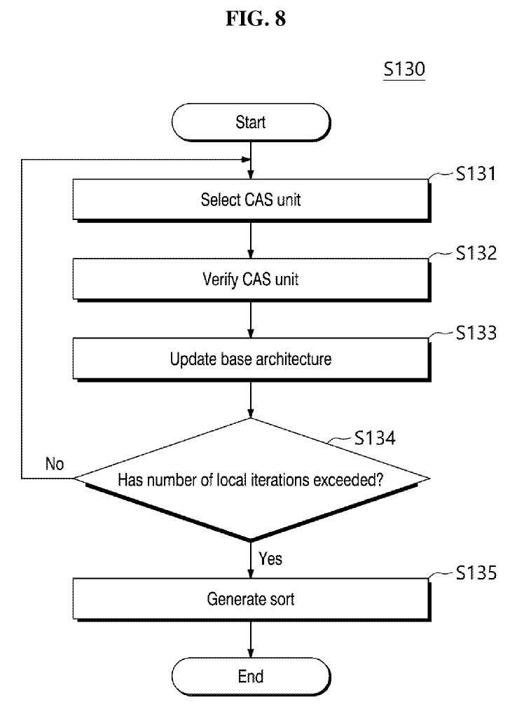

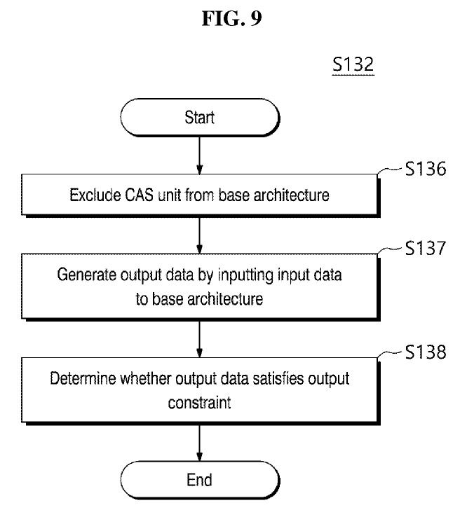

FIG. 7 is a flowchart for explaining a method for generating a network sorter according to an embodiment of the present disclosure, FIG. 8 is a flowchart for explaining a process for repeatedly performing a local operation illustrated in FIGS. 7, and 9 is a flowchart for explaining a process for verifying the validity of a CAS unit illustrated in FIG. 8.

Referring to FIGS. 2 and 7, a method for generating a network sorter using a network sorter generating apparatus 100 is described.

According to the method of generating a network sorter (S100), input constraints 10 and output constraints 20 of the sorter are received (S110). Here, the input constraints 10 may include the number of input signals of the sorter and relationship information between respective signals. For example, the relationship information may include information regarding a plurality of signals, such as that a signal value at index no. 1 is always smaller, or that an odd-indexed signal value is greater than an even-indexed signal value. The input constraints 10 based on such information may indicate, for example, that there are eight inputs and that the signal value at index no. 3 is the largest. The output constraints 20 may include sorting conditions of the input signals. For example, output constraints may include sorting conditions such as sorting a plurality of input signals in ascending order, sorting in descending order, or sorting only the five largest signal values.

Then, based on the input constraints 10, a first base architecture is selected from among a plurality of preset base architectures (S120), and a local operation is performed on the first base architecture (S130) to generate a first sorter using the first base architecture.

Here, the base architecture may be a sorter such as a Bitonic sorter, an odd-even sorter, a hybrid sorter, or a Pairwise sorter, and the base architecture may be selected based on the number of input signals included in the input constraints 10. For example, if the number of input signals included in the input constraints is 8, an 8-input Bitonic sorter may be selected as the first base architecture.

Thereafter, the temporary sorter is updated based on the efficiency between the first sorter and the sorter set as the temporary sorter (S140), and it is determined whether the number of times the sorter has been generated is equal to or greater than the number of global iterations (IG) (S150).

At this time, if the number of times the sorter is generated is equal to or greater than the number of global iterations (IG), the sorter set in the temporary sorter may be provided as the final sorter (S160), and if the number of times the sorter is generated is less than the number of global iterations (IG), the process returns to step S120 to select the second base architecture, and steps S130 and S140 may be performed for the second base architecture.

Thereafter, the process of performing local operation for the first base architecture (S130) will be specifically described with reference to FIGS. 2 and 8.

The network sorter generating apparatus 100 selects a first CAS unit, which is one of a plurality of compare-and-swap (CAS) units constituting the first base architecture selected in step S120 (step S131), and verifies the validity of the first CAS unit by determining whether the operation of the first base architecture excluding the first CAS unit satisfies the output constraints (S132). Here, the validity verification of the CAS unit is a process of determining whether the CAS unit affects the operation of the base architecture, and whether the base architecture operates properly or not without the CAS unit. In other words, the validity verification is the process of verifying whether the CAS unit can be removed from the sorter, and the validity verification process of the CAS unit is described in detail below.

And, based on the validity verification result for the first CAS unit in step S132, the first CAS unit is removed from the first base architecture or maintained to update the first base architecture (S133), and it is determined whether the update of the first base architecture (step S133) has been repeated at least the number of local iterations (IL) (S134).

At this time, if the update of the first base architecture (S133) has been repeated at least the number of local iterations (IL), the updated first base architecture may be generated by the first sorter (S135).

On the other hand, if the update of the first base architecture (S133) is repeated less than the number of local iterations (IL), the process may return to step S131, select a second CAS unit among the plurality of CAS units constituting the first base architecture (S131), and perform a process of verifying the validity of the CAS unit for the second CAS unit (S132) and a process of updating the first base architecture according to the validity verification result (step S133).

Next, with reference to FIG. 9, the process of verifying the validity of the first CAS unit (step S132) will be described in detail. The network sorter generating apparatus 100 excludes the first CAS unit from the first base architecture (S136) and inputs input data to the first base architecture from which the first CSA unit is excluded, to generate output data (S137). Then, the validity of the first CAS unit is verified by determining whether the output data satisfies the output constraints (S138).

Here, the input data includes a plurality of signals, and each signal value may be set to 0 and 1. For example, if the first base architecture is 4 inputs, the input data may be [0, 1, 1, 0].

The network sorter generating apparatus 100 inputs input data composed of 0 and 1 into the first base architecture from which the first CAS unit has been removed, to generate output data, and performs validity verification on the first CAS unit by comparing the output data with output constraints. For example, if the input data is [0, 1, 1, 0] and the output constraint is to sort in ascending order, it is possible to determine whether the first CAS unit affects the operation of the first base architecture by checking whether the output data is sorted as [0, 0, 1, 1].

In addition, the network sorter generating apparatus 100 may generate new input data by rearranging a plurality of signals included in the input data and input the new input data into the first base architecture from which the first CAS unit has been removed, to perform validity verification on the first CAS unit.

More specifically, the network sorter generating apparatus 100 may divide n signal values included in the first input data into m groups (n > m), and may generate second input data by rearranging at least one signal value included in a first group to a second group.

The operation of the network sorter generating apparatus 100 of rearranging input data is described as an example with reference to FIG. 6. Referring to (a) of FIG. 5, the first input data is 8 inputs, and each signal contains only one signal value. The sorter-generation program may divide the eight signals included in the first input data into four groups each consisting of two signals, and rearrange at least one signal included in each group to another group. That is, among the first and second signals included in the first group (m1), the second signal may be rearranged to the second group (m2), and the third signal included in the second group (m2) may be rearranged to the first group (m1).

(b) of FIG. 5 shows a process of dividing eight signals into two groups each consisting of four signals, and rearranging three signals in each group by exchanging them, and (c) of FIG. 5 shows a process of dividing four signals into two groups each consisting of two signals, each signal including two signal values, and rearranging one signal by exchanging it.

The network sorter generating apparatus 100 rearranges input data in this way to generate new input data, and through this, inputs a plurality of input data into the first base architecture from which the first CAS unit has been removed, to generate a plurality of output data, and use the plurality of output data to verify the validity of the first CAS unit.

If a plurality of output data do not satisfy the output constraints in step S138, it is determined that the first CAS unit affects the operation of the first base architecture, and this may be indicated as a validity verification failure of the first CAS unit. That is, the first CAS unit failed the validity verification for removal, as it is a unit required for the final sorter structure.

On the other hand, if the output data satisfies the output constraints in step S138, it is determined that the first CAS unit does not affect the operation of the first base architecture, and this can be indicated as a success in the validity verification of the first CAS unit. That is, since the first base architecture operates correctly even when the first CAS unit is excluded, it means that the validity verification for removal was successful.

If the validity verification of the first CAS unit fails in step S138, an update is performed to maintain the first CAS unit by restoring the excluded first CAS unit back to the first base architecture as shown in FIG. 3 in step S133, and if the validity verification of the first CAS unit succeeds in step S138, an update to remove the first CAS unit from the first base architecture as shown in FIG. 4 may be performed in step S133.

The process of performing local operations in this way (S130) may produce two results.

A process for performing a local operation (S130) will be described as an example with reference to FIG. 6. The network sorter generating apparatus 100 selects a first CAS unit among a plurality of CAS units constituting a first base architecture (S131), and determines whether the operation of the first base architecture excluding the first CAS unit satisfies output constraints, thereby verifying validity of the first CAS unit (S132). Further, based on the result of the validity verification of the first CAS unit, it is determined whether to remove the first CAS unit, and the first base architecture is updated (S133). In FIG. 5, if the validity verification fails, i.e., if the output data does not satisfy the output constraints, the first CAS unit performs an update (S133) to restore the excluded first CAS unit back to the first base architecture 30.

In this way, when the cycle for the first CAS unit is completed, it is determined (S134) whether the update of the first base architecture 30 (S133) has been repeated at least the number of local iterations (IL).

Since FIG. 6 shows that the update (S133) of the first base architecture 30 is not repeated as many times as the number of local iterations (IL), the second CAS unit is selected (S131) from among the plurality of CAS units constituting the first base architecture 30 again, and validity verification (S132) is performed on the second CAS unit. If the second CAS unit is successful in validity verification, the second CAS unit does not affect the operation of the first base architecture, so the second CAS unit may be removed from the first base architecture 40 to update the first base architecture 30 (S133).

The network sorter generating apparatus 100 may generate a first sorter 40 by repeating the process of selecting CAS units (S131) as many times as the number of local iterations (IL), verifying the validity of the selected CAS units (S132), and updating the base architecture (S133).

When the network sorter generating apparatus 100 creates a first sorter 50 using the first base architecture 40 through step S130, it compares the efficiency between the first sorter 50 and the sorter set as the temporary sorter, and performs an operation of setting the sorter with higher efficiency as the temporary sorter (S140).

Here, the temporary sorter is set to the initially generated sorter at the beginning of the operation, and may be updated by comparing the efficiency between the sorter created as the local operation 160 ends and the sorter set to the temporary sorter.

In this way, when the temporary sorter is updated (S140), one cycle of global operation 150 is terminated, and the network sorter generating apparatus 100 determines whether the sorter has been generated as many times as the number of global iterations (IG), and may perform the global operation 150 again or provide the final sorter depending on the number of sorters generated.

If the sorter is generated less than the number of global iterations (IG), the network sorter generating apparatus 100 returns to step S120, selects a second base architecture from among a plurality of base architectures, and performs steps S130 and S140 for the second base architecture. On the other hand, if the sorter has been generated as many times as the number of global iterations (IG), the network sorter generating apparatus 100 may provide the sorter set in the temporary sorter as the final sorter (S160).

That is, sorters are created as many times as the number of global iterations (IG), and the most efficient sorter may be set in the temporary sorter and be finally provided. For example, if the number of global iterations (IG) is 50, sorters may be generated from the first to the 50th sorter, and each time a sorter is generated, the efficiency is compared with the sorter set in the temporary sorter, and the sorter set in the temporary sorter may be maintained, or the temporary sorter may be updated with the generated sorter.

The above description is merely an example of the technical idea of the present embodiment, and those with ordinary knowledge in the technical field to which the present embodiment belongs will be able to make various modifications and variations without departing from the essential characteristics of the present embodiment. Accordingly, these embodiments are not intended to limit the technical idea of the present embodiment but rather to explain it, and the scope of the technical idea of the present embodiment is not limited by these embodiments. The scope of protection of this embodiment should be interpreted by the claims below, and all technical ideas within the equivalent scope should be interpreted as being included in the scope of rights of this embodiment.

1. An apparatus for generating a network sorter which sorts an input signal, the apparatus comprising:
a memory in which a sorter-generation program is stored; and
a processor configured to execute the sorter-generation program,
wherein the sorter-generation program is configured to receive an input constraint and an output constraint, select a first base architecture from among a plurality of preset base architectures based on the input constraint, and repeatedly perform a local operation on the first base architecture to generate a first sorter,
wherein the local operation includes selecting one CAS unit from among a plurality of compare-and-swap (CAS) units constituting the first base architecture, verifying a validity of the CAS unit by determining whether an operation of the first base architecture excluding the CAS unit satisfies the output constraint, and updating the first base architecture by determining whether to remove the CAS unit based on a result of verifying the validity.

2. The apparatus of claim 1, wherein the sorter-generation program inputs input data to the first base architecture excluding the CAS unit to generate output data, and performs validity verification on the CAS unit by determining whether the output data satisfies the output constraint.

3. The apparatus of claim 2, wherein the sorter-generation program determines that the CAS unit does not affect the operation of the first base architecture when the output data satisfies the output constraint, and updates the first base architecture by removing the CAS unit from the first base architecture.

4. The apparatus of claim 2, wherein the sorter-generation program determines that the CAS unit affects the operation of the first base architecture when the output data does not satisfy the output constraint, and updates the first base architecture by restoring the CAS unit to the first base architecture.

5. The apparatus of claim 2, wherein a value of each signal included in the input data is set to 0 or 1,
wherein the sorter-generation program performs validity verification on the CAS unit by comparing first output data of the first base architecture excluding the CAS unit for the input data consisting of 0s and 1s with second output data that satisfies the output constraint.

6. The apparatus of claim 5, wherein the sorter-generation program rearranges each signal of the first input data to generate second input data, and performs validity verification on the CAS unit using the second input data.

7. The apparatus of claim 6, wherein the sorter-generation program divides n signals included in the first input data into m groups (n > m), and generates the second input data by rearranging at least one signal included in a first group to a second group.

8. The apparatus of claim 1, wherein the sorter-generation program generates the sorter by repeating the local operation a number of local iterations for the base architecture.

9. The apparatus of claim 8, wherein the sorter-generation program compares an efficiency between a generated sorter and a temporary sorter, and sets a sorter with a higher efficiency as the temporary sorter,
wherein the efficiency is calculated based on a number of CAS units and a number of steps.

10. The apparatus of claim 9, wherein the sorter-generation program provides a sorter set in the temporary sorter as a final sorter if the generating of the sorter has been repeated a number of global iterations.

11. The apparatus of claim 10, wherein the sorter-generation program selects one of the plurality of base architectures and repeatedly performs the local operation if the generating of the sorter has been repeated less than the number of global iterations.

12. The apparatus of claim 1, wherein the input constraint includes a number of input signals and relationship information for each input signal value,
wherein the output constraint includes a sorting condition of the input signals.

13. A method of generating a network sorter for sorting an input signal using an apparatus for generating a network sorter, the method comprising:
receiving an input constraint and an output constraint;
selecting a first base architecture from among a plurality of preset base architectures based on the input constraint; and
generating a first sorter by repeatedly performing a local operation for the first base architecture,
wherein the local operation includes:
selecting one CAS unit among a plurality of compare-and-swap (CAS) units constituting the first base architecture;
verifying validity of the CAS unit by determining whether an operation of the first base architecture excluding the CAS unit satisfies the output constraint; and
updating the first base architecture by determining whether to remove the CAS unit based on a result of verifying the validity.

14. The method of claim 13, wherein the verifying of the validity of the CAS includes inputting input data to the first base architecture excluding the CAS unit to generate output data, and performing validity verification on the CAS unit by determining whether the output data satisfies the output constraint.

15. The method of claim 14, wherein the verifying of the validity of the CAS unit includes determining that the CAS unit does not affect the operation of the first base architecture if the output data satisfies the output constraint,
wherein the updating of the first base architecture includes updating the first base architecture by removing the CAS unit from the first base architecture.

16. The method of claim 15, wherein the verifying of the validity of the CAS unit includes determining that the CAS unit affects the operation of the first base architecture if the output data does not satisfy the output constraint,
wherein the updating of the first base architecture includes updating the first base architecture by restoring the CAS unit to the first base architecture.

17. The method of claim 14, wherein a value of each signal included in the input data is set to 0 or 1,
wherein the verifying of the validity of the CAS unit includes performing validity verification on the CAS unit by comparing first output data of the first base architecture excluding the CAS unit for the input data consisting of 0s and 1s with second output data that satisfies the output constraint.

18. The method of claim 17, wherein the verifying of the validity of the CAS unit includes rearranging each signal of the first input data to generate second input data, and performing validity verification on the CAS unit using the second input data.

19. The method of claim 18, wherein the verifying of the validity of the CAS unit includes dividing n signals included in the first input data into m groups (n > m), and generating the second input data by rearranging at least one signal included in a first group to a second group.

20. The method of claim 13, wherein the generating of the first sorter includes generating the first sorter by repeating the local operation a number of local iterations for the first base architecture.

21. The method of claim 13, further comprising comparing an efficiency between the first sorter and a temporary sorter, and setting a sorter with a higher efficiency as the temporary sorter,
wherein the efficiency is calculated based on a number of CAS units and a number of steps.

22. The method of claim 21, further comprising providing a sorter set in the temporary sorter as a final sorter if the sorter has been generated a number of global iterations.

23. The method of claim 22, further comprising selecting the base architecture if the sorter is generated less than the number of global iterations.
